(19) United States
(12) Patent Application Publication
(10) Pub. No.: US 2022/0017073 A1
(43) Pub. Date: Jan. 20, 2022

(54) Parking Assistance System for Carrying Out Automated Maneuvers of Various Types Assisted by the System, With a User Interface

(71) Applicant: Bayerische Motoren Werke Aktiengesellschaft, Muenchen (DE)

(72) Inventors: Simone FUCHS, Muenchen (DE); Marlene GOTTSTEIN, Muenchen (DE); Felix LAUBER, Muenchen (DE); Desiree LOEBEL, Muenchen (DE); Andreas VON EICHHORN, Muenchen (DE)

(21) Appl. No.: 17/298,127

(22) PCT Filed: Nov. 28, 2019
(86) PCT No.: PCT/EP2019/082844

§ 371 Date: May 28, 2021

(30) Foreign Application Priority Data
Dec. 17, 2018 (DE) 10 2018 132 464.2

(51) Int. Cl. B60W 30/06; B62D 15/02

(52) U.S. Cl. CPC B60W 30/06; B62D 15/0285; B62D 15/028

(57) ABSTRACT

A parking assistance system for a motor vehicle includes a user interface for interaction with the user and a control unit. The control unit is configured to display various types of maneuver which can be selected on the user side in a maneuver type display. In addition, the control unit is configured to receive a selection of a maneuver type from the displayed maneuver types. In addition, the control unit is configured to display a set of available maneuver targets only for the selected maneuver type, which targets can be selected by the user via the user interface, on a maneuver target display of the user interface. The system then receives a selection of a maneuver target from the set of available maneuver targets for the selected maneuver type. The selected maneuver target is then parked with at least automated lateral guidance for the selected maneuver type.

### BACKGROUND AND SUMMARY OF THE INVENTION

The invention relates to a parking assistance system for a motor vehicle, in particular for an automobile, for carrying out automated maneuvers of various maneuver types assisted by the system, with at least automated lateral guidance, wherein the parking assistance system comprises a user interface for interaction with the user of the parking assistance system.

Parking assistance systems for carrying out automated maneuvers with at least automated lateral guidance, in which the control of the vehicle is performed partially or completely by the parking assistance, are known. The parking assistance system may assist various automated maneuver types, for example automated rearward longitudinal parking into a longitudinal parking space on the basis of a calculated driving trajectory and automated lateral parking into a lateral parking space on the basis of a calculated driving trajectory. Further maneuver types can be, for example, execution of a previously recorded maneuver or driving along a distance which has been most recently driven along, in a driving direction opposed to the original driving direction.

When an automated maneuver with automated lateral guidance is carried out, the driver is relieved of performing the driving task of steering and the vehicle is steered, for example, along a calculated trajectory into a longitudinal parking space or a lateral parking space. If in this context only the lateral guidance is performed by the system, the driver also activates the brake pedal and accelerator pedal for the manual longitudinal guidance. When an automated maneuver with automated lateral and longitudinal guidance is carried out, the drive, the brake and, if appropriate, also an automatic transmission are also additionally controlled by the vehicle.

In order to display a user interface of a parking assistance system, for example a parking pushbutton key in the cockpit of the vehicle is activated or the reverse gear is engaged. The displaying user interface displays, for example, the current status of the search for a parking space and, if appropriate, displays parking spaces suitable for automated parking. The driver can then select a proposed parking space for an automated maneuver via the user interface, for example by a contact selection on a touch-sensitive screen or by activating a suitable operator control element (e.g. a central operator control element in the form of a turn and push actuator on the center console).

In so far as the parking assistance system assists various maneuver types (longitudinal parking and lateral parking), and therefore under certain circumstances, in contrast to the just single assisted maneuver type in the current situation, a relatively large number of maneuver targets can be parked at in an automated fashion and offered to the user on a display of the user interface (e.g. two parking spaces for longitudinal parking and two parking spaces for lateral parking), it may be confusing for the user to select a desired maneuver with a maneuver target via the user interface.

An object of the invention is to specify a parking assistance system for carrying out automated maneuvers of various maneuver types which are assisted by the system, the user interface of which system permits the user to carry out an easily comprehensible and convenient selection of a maneuver target.

The object is achieved by the claimed invention.

A first aspect of the invention relates to a parking assistance system for a motor vehicle, in particular an automobile, for carrying out automated maneuvers of various maneuver types assisted by the system, with at least automated lateral guidance. The individual maneuver types may be respectively a maneuver type with just automated lateral guidance or a maneuver type with automated lateral and longitudinal guidance.

The parking assistance system comprises a user interface for interaction with the user of the parking assistance system. The user interface can be located in the vehicle cockpit and comprises, for example, a preferably touch-sensitive screen in the vehicle cockpit. Alternatively, it would, however also be conceivable for the user interface to be presented by a vehicle-external mobile device (e.g. smartphone or vehicle radio key).

The system is configured to carry out various activities as described below. This occurs typically by using an electronic control unit which can also be distributed over a plurality of control devices. The control unit can comprise one or more processors which operate in an inventive fashion under the control of one or more software programs.

The parking assistance system is configured to display, for selection, various types of maneuvers, which can be selected by the user, on a maneuver type display of the user interface. The various maneuver types which can be selected by the user are displayed, for example, in a list, e.g. a vertical or a horizontal bar, on the maneuver type display. In addition, the parking assistance system is configured to receive a user-side selection of a maneuver type from the maneuver types displayed on the maneuver type display. There may be provision for this that, per maneuver type which can be selected by a user, in each case one maneuver selection element associated with the respective maneuver type and by use of which the respectively assigned maneuver type can be selected by the user is displayed on the maneuver type display. Depending on the implementation, the selection can be carried out, for example, by touching the displayed maneuver type selection element on a touch-sensitive screen or by activating an operator control element which is separate from the screen (e.g. a central operator control element on the center console), wherein in the second case the desired maneuver type selection element is highlighted, for example, by one or more movements (e.g. tilting movements) of the central operator control element and is then selected, for example, by pressing. However, it would also be conceivable for a maneuver type to be selected by a voice command of the user or by a gesturing free space.

In addition, the parking assistance system is configured to display, for example in a plan view on a maneuver target display of the user interface after the user-side selection of a maneuver type, a set of available maneuver targets, which can be selected by the user via the user interface only for the selected maneuver type and not for other maneuver types. A maneuver target display is presented, for example, on a screen only after the selection of the maneuver type. Before the selection, a camera-based plan view of the relatively close surroundings of the vehicle are presented, for example, on this area of the screen; after the selection, the maneuver target display is presented in plan view at this area of the screen, with relatively small scale in comparison with the previous camera-based plan view, so that various maneuver targets in the surroundings of the vehicle can be presented.

Such a maneuver type therefore forms a cluster of possible maneuvers of the same type (e.g. rearward longitudinal parking into various parking spaces). However, it is to be noted that not every maneuver type which is assisted by the system has to assist various maneuver targets (for example different maneuver targets are typically not displayed for a reversing assistant maneuver type). A plurality of maneuver targets are respectively preferably assisted by the system for at least two maneuver types (e.g. longitudinal parking and lateral parking) which are presented on the maneuver type display.

The available maneuver targets for the maneuver type can, for example, be presented simultaneously on the maneuver target display. It would alternatively also be conceivable for the available maneuver targets to be presented successively with a corresponding maneuver-target-changeover operator control action by the user. A maneuver target can be displayed, for example, as a rectangle, in particular in the case of a parking space, and/or as an arrow or path (the maneuver target is then at the end of the arrow/path) on the maneuver target display.

This system then receives a user-side selection of a maneuver target from the set of available maneuver targets for the selected maneuver type, for example by touching a presented maneuver target or by pushing the central operator control element depending on the implementation.

Parking is then carried out at the selected maneuver target with at least automated lateral guidance (or even with automated longitudinal and lateral guidance) with the selected maneuver type.

The parking assistance system according to embodiments of the invention, with its user interface, permits easily comprehensible and convenient selection of a maneuver target by the driver. By clustering the maneuvers of the same type into individual maneuver types and presenting the individual maneuver targets only for the respectively selected maneuver type, the presentation remains easily comprehensible even when there are a multiplicity of parking possibilities:

in comparison with a form of presentation in which all the maneuver targets which are available in the situation are to be presented in a list (for example as a vertical bar) a list of available maneuver types is significantly shorter. This is helpful, in particular, against the background when the display area for the maneuver type display has a width and a length of only three to four selection elements, in order to ensure easy selection by contact by the user.

In comparison with a form of presentation in which all the maneuver targets which are available in the situation are displayed simultaneously on a maneuver target display, the presentation according to embodiments of the invention of only the maneuver targets which are assigned to the selected maneuver type is significantly more easily comprehensible. The concept according to the invention permits overlap-free presentation of parking spaces as maneuver targets in a plan view.

The maneuver targets do not necessarily have to be targets relating to parking (for example parking spaces). Maneuver targets relating to exiting a parking space would also be conceivable (e.g. exiting a parking space to the left and exiting a longitudinal parking space to the right).

For example, clustering according to one of the following maneuver types can be provided, wherein depending on the availability of the plurality of maneuver targets can be present for each maneuver type:
longitudinal parking (right-hand and left-hand side of the roadway, in each case—from the point of view of the vehicle—the first and second parking spaces behind the vehicle);
lateral parking with a vehicle which is parked in a forward direction after the end of the lateral parking (right-hand and left-hand side of the roadway, in each case—from the point of view of the vehicle—the first and second parking spaces behind the vehicle);
lateral parking with a vehicle which is parked rearward after the end of the lateral parking (right-hand and left-hand side of the roadway, in each case—from the point of view of the vehicle—the first and second parking spaces behind the vehicle); and/or
exiting a parking space (to the left and to the right).

The parking assistance system is preferably configured to display, on the maneuver type display of the user interface, the various maneuver types which can be selected by the user, in a list ordered according to a specified prioritization of the maneuver types, in particular together or one next to the other on the maneuver type display. The maneuver type with the highest priority is, for example, arranged at the top in a vertical list of maneuver types or on the left in a horizontal list of maneuver types.

A fixed prioritization can be provided for the individual maneuver types which are basically assisted by the system (i.e. independently of a specific parking situation). Maneuver types which are not available in the specific situation are preferably not presented in the list of maneuver types. The prioritization between individual maneuver types does not have to be fixed but rather could also be determined dynamically as a function of current parameters, for example as a function of the dimensions of detected parking spaces. For example, in the case of a lateral parking space which is located in the surroundings and which is larger than a longitudinal parking space which is located in the surroundings, lateral parking could be prioritized over longitudinal parking.

The maneuver types which can be selected comprise, for example, rearward longitudinal parking into a longitudinal parking space and at least one maneuver type of lateral parking into a lateral parking space. The longitudinal parking preferably has here a higher priority than lateral parking. However, it would also be conceivable for the prioritization between the longitudinal parking and the lateral parking to be location-dependent, in particular dependent on the country. The prioritization between longitudinal parking and lateral parking could in the second case be dependent on, for example, location information about the current location of the vehicle which is provided by a satellite navigation system.

The maneuver types which can be selected comprise, for example, rearward longitudinal parking to longitudinal parking space and two lateral parking maneuver types, specifically lateral parking into a lateral parking space with a motor vehicle which is parked in a forward direction after the end of the lateral parking and lateral parking into a lateral parking space with a motor vehicle which is parked in a rearward direction after the end of the lateral parking. In this case, preferably longitudinal parking has higher priority than lateral parking with a motor vehicle which is parked in a forward direction after the end of the lateral parking, wherein the lateral parking with a motor vehicle which is parked in a forward direction after the end of the lateral parking has a higher priority than lateral parking with a motor vehicle which is parked in a rearward direction after the end of the lateral parking.

The maneuver types which can be selected to do not only have to be classic parking maneuvers: the maneuver types comprise (in addition to rearward longitudinal parking in a longitudinal parking space and/or at least one maneuver type of lateral parking into a lateral parking space) for example one or more of the following additional maneuver types:
automated maneuvering with a trailer (AHA),
automated execution of a recorded maneuver (AMA),
automated driving along a distance which has most recently been driven along in a driving direction which is opposite to the original driving direction (RFA).

In the maneuver type AHA the driver specifies the direction of the trailer directly by using the central operator control element in the case of rearward driving. The system performs the steering of the tractor vehicle by performing closed-loop control of the articulation angle of the vehicle combination. The longitudinal guidance is carried out by the driver; however, automated longitudinal guidance would also be conceivable.

As stated above, there can be provision that individual maneuver types or all the additional maneuver types do not assist different maneuver targets.

The parking assistance system is preferably configured to display, on the maneuver type display, the selectable maneuver types including the one or more additional maneuver types in a list ordered according to a specified prioritization of the maneuver types.

For example, the following prioritization can then be provided:

AHA>AMA>PA>RFA

(where “>”=with higher priority than)

Here, PA describes one or more classic parking maneuver types (in particular with a parking maneuver which is measured as a the vehicle travels past) such as, for example, rearward longitudinal parking, both types of lateral parking above and exiting a parking space. An exemplary prioritization within the set PA of parking maneuver types has already been described above.

If the maneuver type AHA is available (because, for example, the presence of a trailer which is coupled to the vehicle has been detected), preferably no further maneuver types are displayed in the list.

In addition, the presented list of maneuver types can also be supplemented with a further selectable element which serves to record a new maneuver for the function AMA described above, for example with minimum priority in the list.

If the parking assistance system also assists a maneuver type for the automated positioning of an electric vehicle or plug-in hybrid vehicle, which can be charged with electrical energy, at a charging interface (e.g. at inductive charging coil), this maneuver type
in so far as it is currently available in the situation—can be displayed at the location with the highest priority in the presented list. If a plurality of charging interfaces are located in the immediate surroundings of the vehicle, there can be provision that different maneuver targets are also presented on the maneuver target display.

It is advantageous if the parking assistance system is configured to identify, while taking into account information on the surroundings which is determined by a surroundings sensor system (e.g. ultrasonic sensor system), a set of available maneuver types which are available for use in the respective situation, from a set of maneuver types which are (generally) assisted by the parking assistance system.

For this purpose, parking spaces which are located in the surroundings of the vehicle can be detected, for example, for the classic parking maneuver types such as longitudinal parking and lateral parking on the basis of information on the surroundings, and the dimensions of said parking spaces (length and width) can be determined. On the basis of the dimensions it is possible to determine, for each parking space, whether it is a longitudinal parking space or a lateral parking space which is sufficiently large to be parked in. Parking spaces which are not sufficiently large for longitudinal parking or lateral parking are not taken into account any further. For the sufficiently large spaces it is checked whether it is possible to determine a collision-free trajectory with a permissible parking end position within the scope of the path planning for longitudinal parking or lateral parking. If at least one parking space can be determined for rearward longitudinal parking, lateral parking with a vehicle which is parked in a rearward direction or lateral parking with the vehicle which is parked in a forward direction can be determined which satisfies the criteria above, the respective parking maneuver type is available in the situation.

In order to determine the availability of a maneuver type, other information can be used alongside surroundings information. If the maneuver types comprise, for example, maneuvering with a trailer, in the case of a coupled trailer only maneuvering with a trailer is preferably available as the maneuver type in the current situation.

Moreover, it is advantageous that only the maneuver type of exiting a parking space is defined as available and displayed as a single maneuver type if a parking-space-exiting situation has been detected. A parking-space-exiting situation can be determined, for example, on the basis of the fact that before the vehicle is shutdown it has been parked in an automated fashion by using the system. However, it would also be conceivable to detect a parking-space-exiting situation on the basis of information on the surroundings.

When the maneuver type of exiting a parking space is selected, for example both exiting a parking space to the left and exiting a parking space to the right are offered. If it is additionally known to the vehicle that the vehicle has been parked on the right (or on the left) of the roadway, for example exiting a parking space to the left (or to the right) is pre-selected so that the user can start the parking-space-exiting maneuver with a relatively low number of operator control steps.

The availability of a parking maneuver type for automated positioning of a vehicle at a charging interface which is external to the vehicle can depend, for example, on information about the respective charging interface which is received from a charging interface by a radio.

On the basis of the determined set of maneuver types available in the situation, the available maneuver types are displayed on the maneuver type display, whereas maneuver types which are not available are not displayed. It would alternatively be conceivable to display the available maneuver types as available (for example by a first marking of the respective maneuver type in the list) and to display maneuver types which are not available as not available (for example by a second marking, different from the first marking, of the respective maneuver type in the list).

The list of maneuvers which is presented on the maneuver type display can be updated continuously, in particular when the vehicle moves: a maneuver which has just become available can be dynamically added to the list (preferably according to the prioritization), and a maneuver which is then no longer available can be removed from the list.

It is therefore possible to check continuously during the presentation of the maneuver type display, in particular taking into account information on the surroundings, as to whether a maneuver type which has previously not been available, from a set of the maneuver types which is assisted by the parking assistance system, is available for use in the respective situation, and when the availability of a maneuver type which has previously not been available is detected, this maneuver type can also be displayed on the maneuver type display. When the newly available maneuver type is displayed, this maneuver type is preferably included in the list according to the specified prioritization.

As already outlined above, from the point of view of the vehicle, a first and second available parking space on the same side of the roadway behind the motor vehicle and/or one or more available parking spaces per side of the roadway, on both sides of the roadway are displayed on the maneuver destination display for longitudinal parking or lateral parking. The first and second available parking spaces are preferably displayed respectively for both sides of the roadway if these parking spaces are located within a certain range behind the vehicle (for example with a range of several vehicle lengths behind the vehicle).

For example one or more available parking spaces per side of the roadway are displayed on both sides of the roadway on the maneuver target display, wherein for use in right-hand traffic an available parking space on the right-hand side of the roadway is pre-selected automatically, and for use in left-hand traffic an available parking space on the left-hand side of the roadway is automatically pre-selected. The pre-selection with respect to the left-hand or right-hand side of the roadway can be fixed in the vehicle. However, it would also be conceivable to make the pre-selection dependent on location information about the location of the vehicle which is acquired, for example, by using a satellite-assisted navigation system.

As stated above the various maneuver types which can be selected by the user are presented arranged in a list on the maneuver type display.

After selection of a specific maneuver (e.g. rearward longitudinal parking into the second parking space behind the vehicle), the associated maneuver type (rearward longitudinal parking in the example) is preferably presented as selected on the maneuver type display. The maneuver type initially remains at the same location on the list. Through further activation of the maneuver type selection element (e.g. touching the associated area of the screen or by pressing the central operator control element), the user can deselect the cluster (i.e. the associated maneuver type) or change the cluster (i.e. the maneuver type) by activating another element on the list.

It is advantageous if the selected maneuver type is not shifted to the first position on the list (for example is moved upward on the list) until the maneuver starts (for example in reaction to release of the brake), if this maneuver type was not already at the first position on the list in any case. In particular, the maneuver types which are not selected are then no longer displayed.

This provides the advantage that during the execution of the maneuver the relevant maneuver type at the top of the list can be seen and there is no risk of it disappearing in a long list outside the visible area of the list. As a result of the fact that the shifting to the first position on the list does not take place until the maneuver starts, in the event in the case of interaction by touching the screen the maneuver type selection element is prevented from jumping under the user's finger at the moment of selection.

A second aspect of the invention relates to a method for executing automated maneuvers of various assisted maneuver types with at least automated lateral guidance of a motor vehicle, comprising the following steps:
displaying, for selection, various types of maneuvers which can be selected by the user, on a maneuver type display of a user interface;
receiving a user-side selection of a maneuver type from the maneuver types displayed on the maneuver type display;
displaying on a maneuver target display of the user interface after the selection, a set of available maneuver targets, which can be selected by the user via the user interface, only for the selected maneuver type,
receiving a user-side selection of a maneuver target from the set of available maneuver targets for the selected maneuver type, and
automated parking at the selected maneuver target with the selected maneuver type with at least automated lateral guidance.

The statements above relating to the inventive system according to the first aspect of the invention correspondingly also apply to the inventive method according to the second aspect of the invention.

A third aspect of the invention relates to a piece of software with program code for carrying out the method specified above when the piece of software runs on one or more software-controlled devices.

The invention will be described below on the basis of an exemplary embodiment and with reference to the appended drawings.

### BRIEF DESCRIPTION OF THE DRAWINGS

FIG. 1 shows an exemplary operator control sequence for starting an automated parking process for an exemplary embodiment of the parking assistance system according to the invention; and

FIGS. 2a-2f show exemplary states of a display of the user interface.

### DETAILED DESCRIPTION OF THE DRAWINGS

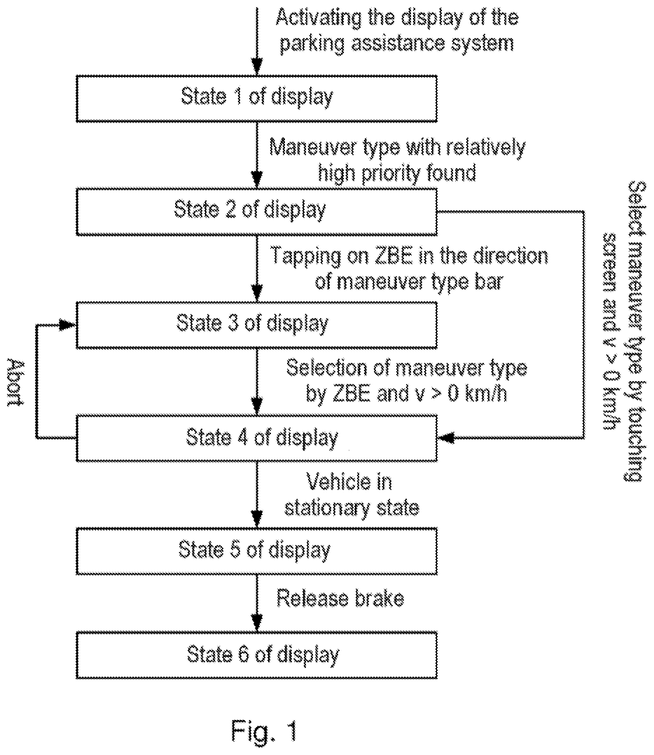

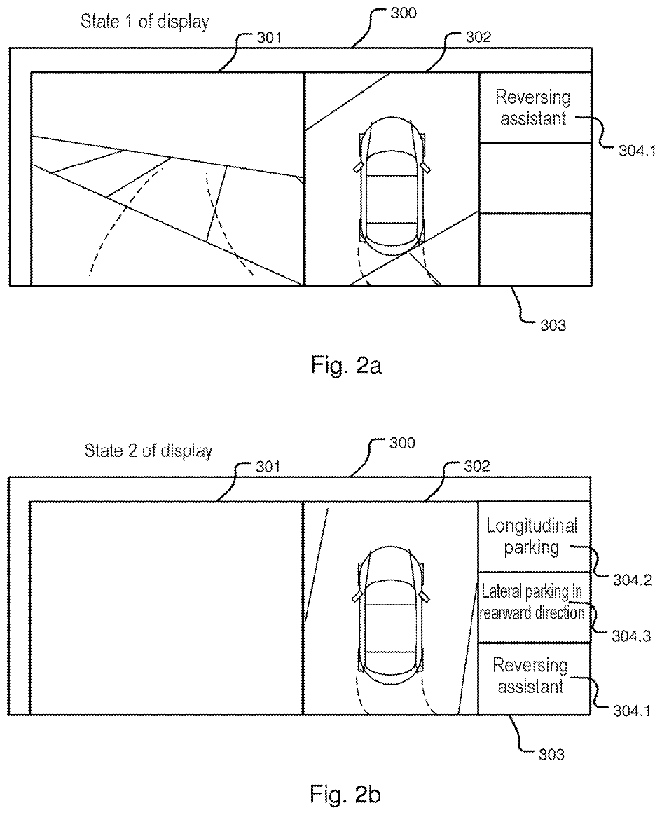

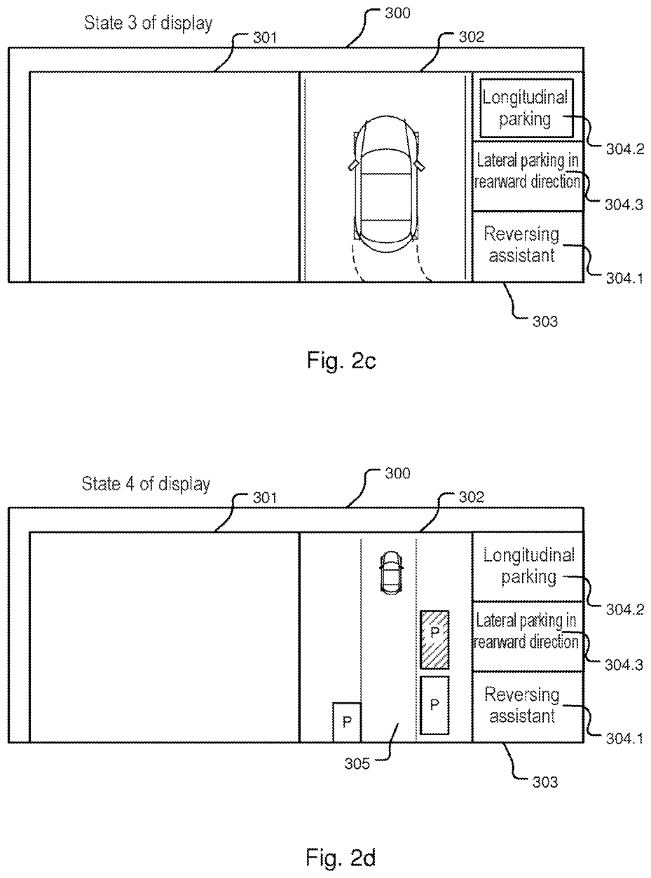

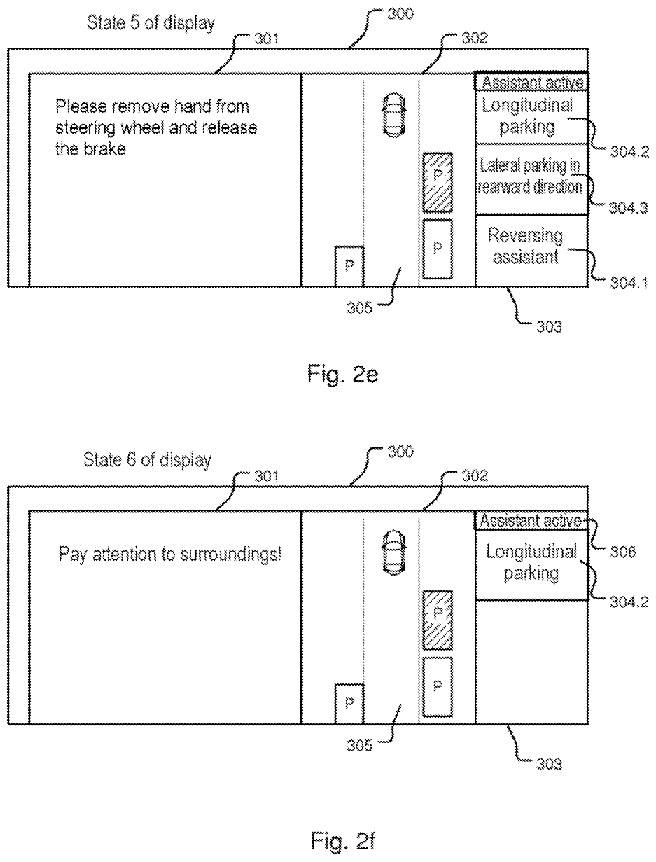

FIG. 1 shows an exemplary operator control sequence for starting an automated parking process for an exemplary embodiment of the parking assistance system according to the invention. Firstly, the user carries out an operator control action for activating the display of the parking assistance system on a screen (e.g. in the center console of the cockpit), for example activating a parking pushbutton key or engaging the reverse gear. This results in the state 1, illustrated by way of example in FIG. 2a, of the display 300 which is presented on the screen. The display 300 has a camera image 301 of the surroundings in a parking direction (here the image from a rear view camera) from the ego perspective and an image 302 of a plan view of the surroundings which is composed of a plurality of camera images. In the plan-view image 302 of the surroundings, the immediate surroundings are illustrated, for example bounded by the range of the ultrasonic sensors. Instead of a camera-based presentation, a non-camera-based presentation would also be conceivable, in which non-camera-based presentation, for example, the outlines of the objects or symbols for the objects are represented. The camera image 301 from the ego perspective preferably has auxiliary lines for the steering lock. In addition, maneuver types which are available in the current driving situation, from the set of maneuver types which are assisted by the system, are presented on a maneuver type display 303 which corresponds to a vertical bar in the example. A maneuver type selection element 304 is presented for each available maneuver type on the maneuver type display 303. In the state 1 which is illustrated in FIG. 2a, for example only the “reversing assistant” maneuver type can be selected by the user (apparent from the assigned maneuver type selection element 304.1).

If the parking assistance system detects at a later point, for example during further travel, that one or more other available maneuver types are available, a corresponding maneuver type selection element is displayed for each further available maneuver type. The available maneuver types are displayed in the sequence of a specified prioritization of the maneuver types on the maneuver type display 303.

FIG. 2b illustrates an exemplary state 2 of the display, in which state 2, for example, rearward longitudinal parking (see selection element 304.2) and lateral parking with a vehicle which is parked in a rearward direction after the end of the parking maneuver (see maneuver type selection element 304.3) are presented as further available maneuver types on the maneuver type display 303. The display 301 is no longer illustrated in FIG. 2b to FIG. 2f for reasons of simplification.

A maneuver type can be selected by tilting the central operator control element (ZBE) in the direction of the maneuver type bar 303 (for example to the right if the maneuver type bar 303 is arranged on the right of the screen). Initially, the state 3 of the display, which is illustrated in FIG. 2c, occurs when the ZBE is tilted in the direction of the maneuver type bar 303. Here, the first maneuver type is pre-selected on the maneuver type bar 303. The pre-selection can be confirmed by pressing the ZBE. Alternatively, rotating the ZBE one or more times and subsequent pressing of the ZBE permits a different maneuver type to be selected.

An exemplary state 4 of the display in which a maneuver type (here the maneuver type of rearward longitudinal parking) has been selected and the speed of the vehicle is still higher than 0 km/h is illustrated in FIG. 2d. Available parking spaces for the selected maneuver type (in this case rearward longitudinal parking) are displayed in the plan-view image 302 of the surroundings. For example, in so far as they are present within a range, a first parking space and a second parking space (the first parking space is closer to the vehicle than the second parking space) behind the vehicle in question are presented for each side of the roadway 305 (marked as rectangles in FIG. 2d). In the case of right-hand traffic, the first parking space is pre-selected on the right-hand side of the roadway (visible from corresponding marking of this parking space). In order to be able to represent the parking spaces satisfactorily, the plan-view image 302 of the surroundings in FIG. 2d is in a smaller scale (zoomed out) in comparison with the previous plan view.

If the driver stops the vehicle and the driver's vehicle has entered a stationary state, the display changes into the exemplary state 5 illustrated in FIG. 2e. Here, the driver is provided with operator control instructions for activating the desired parking maneuver, specifically to take his hands away from the steering wheel and to release the brake. If it has been detected that the brake has been released, the automated parking maneuver starts. When the automated parking maneuver starts, the state 6 of the display which is illustrated in FIG. 2f is obtained. If the selected maneuver type was not already at the top of the list of maneuver types, the maneuver type is moved upward in the list. Furthermore, the maneuver types which have not been selected are no longer presented. Furthermore, an indication that the parking assistance system is active is provided (see 306 in FIG. 2f).

As an alternative to the operator control by using the ZBE, the display can be transferred directly into the state 4 by touching the desired maneuver selection element in the state 2.

In addition it is to be noted that in the state 4 the user can deselect the selected maneuver type, abort the state 4 and change into the state 3 by renewed selection of the maneuver selection element, which has already been selected, by using the ZBE (pressing the ZBE) or by touching the screen.

1. to 15. (canceled)

16. A parking assistance system for a motor vehicle for carrying out automated maneuvers of various maneuver types assisted by the parking assistance system, the parking assistance system comprising:
a user interface for interaction with a user of the parking assistance system; and
a control unit, wherein the control unit is configured to:
display, for selection, various maneuver types which are selectable by the user, on a maneuver type display of the user interface;
receive a user-side selection of a maneuver type from the maneuver types displayed on the maneuver type display;
display, on a maneuver target display of the user interface after the selection, a set of available maneuver targets, which are selectable by the user via the user interface, for the selected maneuver type,
receive a user-side selection of a maneuver target from the set of available maneuver targets for the selected maneuver type, and
park the selected maneuver target with at least automated lateral guidance for the selected maneuver type.

17. The parking assistance system according to claim 16, wherein the control unit is further configured to display, on the maneuver type display, the various maneuver types which are selectable by the user, in a list ordered according to a specified prioritization of the maneuver types, together on the maneuver type display.

18. The parking assistance system according to claim 17, wherein:
the maneuver types comprise:
rearward longitudinal parking into a longitudinal parking space; and
at least one maneuver type of lateral parking into a lateral parking space, and in the prioritization:
longitudinal parking has a higher priority than lateral parking, or
the prioritization between longitudinal parking and lateral parking is location-dependent.

19. The parking assistance system according to claim 18, wherein
the prioritization between longitudinal parking and lateral parking is dependent on a country.

20. The parking assistance system according to claim 17, wherein:
the maneuver types comprise:
rearward longitudinal parking into a longitudinal parking space;
lateral parking into a lateral parking space with a motor vehicle which is parked in a forward direction after the end of the lateral parking; and
lateral parking into the lateral parking space with the motor vehicle which is parked in a rearward direction after the end of the lateral parking; and
in the prioritization:
longitudinal parking has a higher priority than lateral parking with the motor vehicle which is parked in the forward direction after the end of the lateral parking, and
lateral parking with the motor vehicle which is parked in the forward direction after the end of the lateral parking has a higher priority than lateral parking with the motor vehicle which is parked in the rearward direction after the end of the lateral parking.

21. The parking assistance system according to claim 17, wherein the maneuver types comprise:
at least one of:
rearward longitudinal parking in a longitudinal parking space, and
at least one maneuver type of lateral parking into a lateral parking space, and
at least one of:
parking with a trailer,
executing a recorded maneuver, or
driving along a distance which has most recently been driven along in a driving direction which is opposed to an original driving direction.

22. The parking assistance system according to claim 16, wherein the control unit is further configured to:
identify, while taking into account information on surroundings, a set of available maneuver types which are available for use in a respective situation, from the maneuver types, and
display, on the maneuver type display, the set of available maneuver types, wherein maneuver types which are not available are not displayed.

23. The parking assistance system according to claim 22, wherein the control unit is further configured to:
check continuously during presentation of the maneuver type display, taking into account the information on the surroundings, as to whether a maneuver type which has previously not been available, from the maneuver types, is available for use in the respective situation, and
display, when availability of the maneuver type which has previously not been available is detected, the maneuver type on the maneuver type display in a list of the maneuver types according to a specified prioritization of the maneuver types.

24. The parking assistance system according to claim 16, wherein the control unit is further configured to display, on the maneuver target display:
at least one of:
a first available parking space and a second available parking space on a same side of a roadway behind a motor vehicle, or
one or more available parking spaces per side of the roadway, on both sides of the roadway.

25. The parking assistance system according to claim 24, wherein the control unit is further configured to display, on the maneuver target display, the one or more available parking spaces per side of the roadway, on both sides of the roadway, wherein:
for right-hand traffic an available parking space on the right-hand side of the roadway is pre-selected, and
for left-hand traffic an available parking space on a left-hand side of the roadway is pre-selected.

26. The parking assistance system according to claim 16, wherein the control unit is further configured to:
detect if there is a situation in which a parking space is being exited, and
if the situation in which the parking space is being exited is detected, display only one or more parking-space-exiting maneuver types on the maneuver type display of the user interface.

27. The parking assistance system according to claim 16, wherein the control unit is further configured to:
present, on the maneuver type display, the maneuver types arranged in a list, and
display only a selected maneuver type at a first location on the list during execution of the maneuver, and no longer display non-selected maneuver types.

28. The parking assistance system according to claim 16, wherein the maneuver types comprise:
rearward longitudinal parking in a longitudinal parking space; and
at least one maneuver type of lateral parking into a lateral parking space.

29. The parking assistance system according to claim 28, wherein the at least one maneuver type of lateral parking into the lateral parking space comprises:
both lateral parking into the lateral parking space with a motor vehicle which is parked in a forward direction after the end of the lateral parking, and
lateral parking into the lateral parking space with the motor vehicle which is parked in a rearward direction after the end of the lateral parking.

30. The parking assistance system according to claim 16, wherein the control unit is further configured to display for each maneuver type which is selectable by the user on the maneuver type display, a maneuver type selection element which is assigned to the respective maneuver type and by which the respective maneuver type is selectable by the user.

31. The parking assistance system according to claim 16, wherein the control unit is configured to display, on the maneuver target display of the user interface after the selection, the set of available maneuver targets, which are selectable by the user via the user interface, only for the selected maneuver type.

32. A method for executing automated maneuvers of various assisted maneuver types with at least automated lateral guidance of a motor vehicle, the method comprising:
displaying, for selection, various maneuver types which are selectable by a user, on a maneuver type display of a user interface;
receiving a user-side selection of a maneuver type from the maneuver types displayed on the maneuver type display;
displaying on a maneuver target display of the user interface after the selection, a set of available maneuver targets, which are selectable by the user via the user interface, for the selected maneuver type,
receiving a user-side selection of a maneuver target from the set of available maneuver targets for the selected maneuver type, and
automated parking at the selected maneuver target for the selected maneuver type with at least automated lateral guidance.

33. The method according to claim 32, wherein the set of available maneuver targets, which are selectable by the user via the user interface, are displayed only for the selected maneuver type.

34. A computer-program product comprising a non-transitory computer readable medium having stored thereon program code which, when executed on a processor, a microcontroller, or a programmable hardware component, carries out the acts of:
displaying, for selection, various maneuver types which are selectable by a user, on a maneuver type display of a user interface;
receiving a user-side selection of a maneuver type from the maneuver types displayed on the maneuver type display;
displaying on a maneuver target display of the user interface after the selection, a set of available maneuver targets, which are selectable by the user via the user interface, for the selected maneuver type,
receiving a user-side selection of a maneuver target from the set of available maneuver targets for the selected maneuver type, and
automated parking at the selected maneuver target for the selected maneuver type with at least automated lateral guidance.

35. The computer-program product according to claim 34, wherein the set of available maneuver targets, which are selectable by the user via the user interface, are displayed only for the selected maneuver type.
